(19) United States
(12) Patent Application Publication
(10) Pub. No.: US 2011/0288880 A1
(43) Pub. Date: Nov. 24, 2011

(54) TARGETED HEALTH CARE MESSAGING

(75) Inventor: Donald Craig Waugh, Oakville (CA)

(73) Assignee: PATIENT CARE AUTOMATION SERVICES, INC., Oakville (CA)

(21) Appl. No.: 13/101,639

(22) Filed: May 5, 2011

Related U.S. Application Data
(60) Provisional application No. 61/332,506, filed on May 7, 2010.

(51) Int. Cl. G06Q 50/00

(52) U.S. Cl. 705/2

(57) ABSTRACT

Disclosed are techniques for targeted health care messaging for patients and health care providers. In response to a health care event, such as the generation of a prescription or treatment of a patient, information regarding the health care event is obtained by a messaging server. The messaging server uses this information, or a filtered representation thereof, to select one or more health care messages based on selection criteria associated with the selected messages. The messaging server then provides the selected messages to one or more user devices for presentation to one or more participants in the health care event. In many instances, ethical, legal, and regulatory mandates prohibit disclosure of identifying information for a patient or health care professional participating in the health care event to unauthorized third parties, such as the providers or sources of the message content of the selected messages. As such, the information used to select the targeted messages is obtained or used in a manner that prevents identification of participants in the health care event by unauthorized entities. These targeted health care messaging techniques provide an effective and low-cost mechanism for disseminating health care information to the appropriate audience.

### CROSS-REFERENCE TO RELATED APPLICATION

The present application claims priority to U.S. Provisional Patent Application No. 61/332,506, entitled “Targeted Health Care Messaging” filed on May 7, 2010, and naming as inventor Donald Craig Waugh, the entirety of which is herein incorporated by reference.

### FIELD OF THE DISCLOSURE

The present disclosure relates generally to health care services and relates more particularly to distribution of targeted message content to participants in health services.

### BACKGROUND

Health care management typically involves the activities of a number of entities, including patients, health care providers, pharmaceutical companies, medical device manufacturers, governmental and regulatory agencies, and advisory bodies. It often is difficult to effectively disseminate health care-related information in this fractured environment, as illustrated by the efforts of pharmaceutical representatives. While the duties of pharmaceutical representatives include the education of doctors and patients about both prescribed medicines and new medicines available through phone calls or office visits, the typical pharmaceutical representative's attempts to establish contact with health care providers frequently are unsuccessful due to the difficult schedules of health care providers. Considering the salary and related cost of the pharmaceutical representative, this low proportion of successful contacts presents an unreasonably high expense to the pharmaceutical company. Other health care companies, regulatory agencies, and advisory bodies likewise find it difficult to reach an intended audience using conventional channels of communication.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a diagram illustrating a targeted health care messaging system in accordance with at least one embodiment of the present disclosure;

FIG. 2 is a flow diagram illustrating a method for targeted health care messaging in the system of FIG. 1 in accordance with at least one embodiment of the present disclosure;

FIGS. 3 and 4 are diagrams illustrating targeted health care messaging for a health care provider in the system of FIG. 1 in accordance with at least one embodiment of the present disclosure;

FIGS. 5 and 6 are diagrams illustrating targeted health care messaging for a patient in the system of FIG. 1 in accordance with at least one embodiment of the present disclosure;

FIG. 7 is a flow diagram illustrating a method for selecting a health care message in the system of FIG. 1 in accordance with at least one embodiment of the present disclosure; and

FIG. 8 is a diagram illustrating an example computer system for implementing one or more of the components or techniques described herein in accordance with at least one embodiment of the present disclosure.

The use of the same reference symbols in different drawings indicates similar or identical items.

### DETAILED DESCRIPTION OF THE DRAWINGS

The numerous innovative teachings of the present application will be described with particular reference to the presently preferred example embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

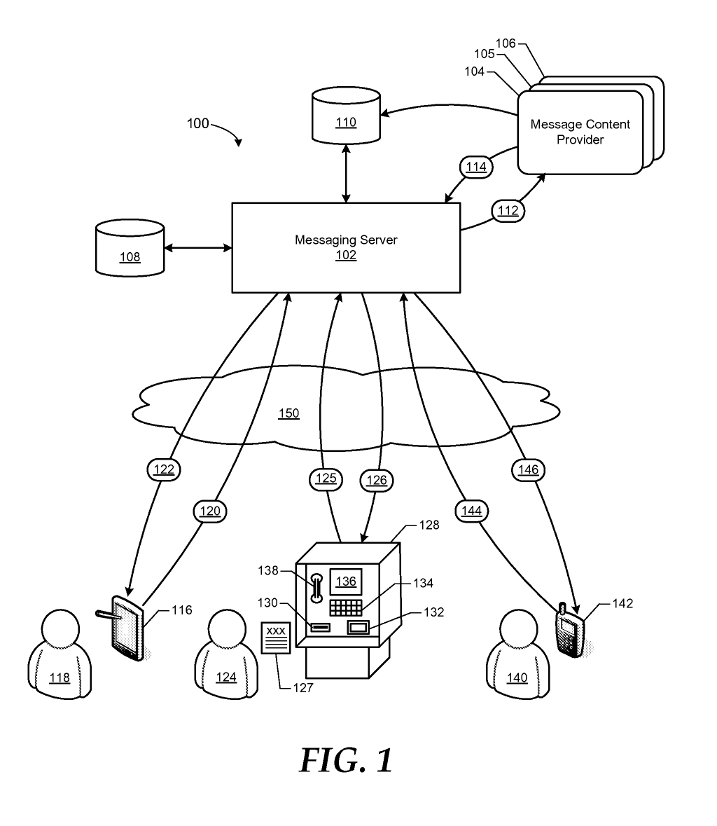

FIGS. 1-8 illustrate techniques for targeted health care messaging for patients and health care providers. In response to a health care event, such as the treatment of a patient or the generation or fulfillment of a prescription, information regarding one or more of the participants in the health care event is obtained by a messaging server. The messaging server selects one or more messages from a set of health care messages based on selection criteria associated with the set of messages and based on this information from the health care event, or a filtered representation thereof. The messaging server then provides the selected messages to one or more user devices for presentation to one or more participants in the health care event. In many instances, ethical, legal, and regulatory mandates prohibit disclosure of identifying information for a patient or health care provider participating in the health care event to unauthorized third parties, such as the providers or sources of the message content of the selected messages. Accordingly, in at least one embodiment the information used to select the messages is obtained or used in a manner that prevents the message content providers or other unauthorized entities from inferring the identification of participants in the health care event.

Many general advertising system techniques do not respect the privacy of the user. To illustrate, many online search engines employ cookies, Internet-Protocol address tracking, and other tracking mechanisms to monitor and track a user's search efforts for advertising purposes. However, these techniques result in the accumulation of information that either directly or inferentially reveals the identity of the user. In contrast, the targeted health care messaging techniques disclosed herein provide an effective and low-cost mechanism for disseminating information to intended audiences when compared to conventional approaches. Further, these techniques maintaining appropriate safeguards against disclosure of private information of the patient or health care provider consistent with patient confidentiality restrictions promulgated by, for example, Ontario's Personal Health Information Privacy Act (PHIPA) or the United States' Health Insurance Portability and Accountability Act (HIPAA). Many conventional search engines

FIG. 1 illustrates a health care messaging system 100 in accordance with at least one embodiment of the present disclosure. The health care messaging system 100 includes a messaging server 102 configured to select or obtain one or more messages for presentation in response to a health care event and provide the selected messages for presentation to one or more participants in the health care event. The health care messaging system 100 further includes one or more message content providers 104, 105, and 106 to provide the content of messages to be distributed by the messaging server 102. The message content providers 104-106 further can provide selection criteria used to select message content that is targeted to particular characteristics of the health care event or one or more participants of the health care event. At some point during or after the health care event, information regarding the health care event is obtained from a user device operated by a participant, from a local records database 108 accessible by the messaging server 102, or a combination thereof. The messaging server 102 uses this information to obtain one or more targeted health care messages for presentation to one or more the participants via a user devices operated by corresponding participant.

In one embodiment, the messaging server 102 is authorized to access patient records, hospital records, or doctors' records or otherwise is authorized to ascertain the identity of one or more of the participants in the health care event. In this instance, the messaging server 102 can maintain or have access to a message database 110, in which message content and corresponding selection criteria are stored. The messaging server 102 thus can compare the obtained information to various selection criteria to identify and select the appropriate messages for presentation. In this manner, the identities of the participants in the health care event cannot be ascertained by the message content providers 104-106 or other unauthorized entities because the message content providers 104-106 are not provided any participant information, but rather merely provide the message content and the selection criteria to be independently utilized by the messaging server 102.

Rather than have the messaging server 102 select the messages, the message content providers 104-106 can operate to select the appropriate messages and provide the selected messages to the messaging server 102. Because the message content providers 104-106 presumably are unauthorized to access patient information or otherwise ascertain the identities of the participants, information from which a participant's identity may be inferred cannot be supplied to the message content providers 104-106 for use in selecting the messages. Accordingly, in one approach the messaging server 102 filters or otherwise processes the obtained information to render filtered information that is less susceptible to being used to infer the identity of a participant. In addition to removing explicit identity information, such as name information, address information, and government identification numbers, this filtering process can include processes that convert more specific information to more general information, such as by converting values to ranges of values, converting narrower ranges of values to broader ranges of values, converting a narrower classification to a broader classification, prohibiting the communication of a particular set of characteristics determined to be sufficient in combination to permit identification of a participant, and so forth. The resulting filtered information can be included in a query 112 to the databases of one or more of the message content providers 104-106. In response to receiving the query 112, a message content provider applies the corresponding selection criteria to the filtered information so as to identify one or more messages targeted to the circumstances represented by the filtered information. The message content provider then replies to the query 112 with a response 114 that includes the content of the one or more selected messages. Further, as it otherwise may be possible to identify the information the messaging server 102 is seeking on the basis of the information sought by the query 112, the health care messaging system 100 can implement a private information retrieval (PIR) protocol or other oblivious transfer mechanism so as to permit the messaging server 102 to conduct queries 112 with a reduced likelihood that a participant's identity is revealed on the basis of the queries 112.

In other instances, the messaging server 102 may not be authorized to access or otherwise ascertain the identities of the participants in the health care event. In this case, rather than providing unfiltered information regarding the health care event to the messaging server 102, the user devices instead employ software messaging agents that filter or otherwise process the information to render filtered information that does not identify the participants. The user devices then supply this filtered information to the messaging server 102, which in turn may query the message database 110 that is local to messaging server 102 for corresponding messages, or query the message content providers for suitable messages targeted to the circumstances of the health care event.

Communications between networked devices typically involve the use of network addresses assigned to the devices, such as Internet Protocol (IP) addresses, and unique device identifiers, such as media access control (MAC) addresses. This information can be used to indirectly ascertain information about a user of a networked device. Accordingly, in addition to filtering out information regarding the health care event that can be used to infer the identities of the participants, the messaging server 102 also can operate to obscure the identity of the devices used by the participants so as to prevent indirect identification of participants through their devices. In one embodiment, the messaging server 102 employs a proxy technique whereby all information regarding the user devices, such as IP addresses and MAC addresses, is stripped from communications between the messaging server 102 and the message content providers 104-106. As such, communications from the messaging server 102 cannot be attributed to a particular user device by the messaging content providers 104-106.

FIG. 1 illustrates three example scenarios for the presentation of targeted health care messages: the office or clinic of a health care provider; a patient's use of an automated dispensary kiosk; and a patient's use of a medical compliance device or home-treatment device. In the first example scenario, a user device 116 is operated by a health care provider 118 in accordance with the health care provider's duties. The health care provider includes any of a variety of people providing or facilitating the provision of health care for a patient, such as a doctor, a psychiatrist, a psychologist, a nurse, a medical technician, a pharmacist, a therapist, and the like. Examples of the user device 116 can include a tablet computer, a notebook computer, a desktop computer, a personal digital assistant, a “smart” cellular phone, and the like. The user device 116 can provide various functionality to the health care provider 118, such as access to electronic medical records (EMR) or electronic prescription applications. To illustrate, the health care provider 118 can include a doctor and the user device 108 can include a tablet computer used by the doctor to access a patient's medical records, generate a prescription for a medicament, document the administration of a medicament or medical procedure, or order/schedule a medical procedure for the patient. In this scenario, the user device 108 obtains information 120 regarding one or more of the health care provider 118, the patient being treated, any medicament being prescribed, or any medical procedure being performed or scheduled for performance, and then sends this information 120, or a filtered representation thereof, to the messaging server 102. The messaging server 102 selects or otherwise obtains one or more messages targeted to the health care provider or the patient based on the characteristics of the health care event represented by the information 120 and then transmits the selected one or more messages 122 to the user device 116 for presentation.

In the second example scenario, a patient 124 presents a prescription 127 to an automated dispensary kiosk 128 (one example of a user device), for fulfillment. Example implementations of such automated dispensaries, also referred to as robotic prescription dispensaries, are described in PCT applications PCT/CA2007/001220 (entitled “Method, System and Apparatus for Dispensing Drugs”) and PCT/CA2009/001186 (entitled “Automated Apparatus for Dispensing Medicaments”), the entireties of which are incorporated by reference herein.

The automated dispensary kiosk 128 operates to recognize either a human readable description or a machine readable description provided with the prescription 127, from which the automated dispensary kiosk 128 accesses related patient information for validation purposes and, upon validation, dispenses the prescribed medicament to the patient 124. In addition to providing a script input mechanism 130 for receiving the prescription 127 and a dispensing mechanism 132 for dispensing the prescribed medicament, the automated dispensary kiosk 128 can provide a user input mechanism 134, such as a touch screen or key pad, for receiving user input, a display screen 136 for displaying visual information, and a teleconferencing mechanism 138 for facilitating a teleconference or videoconference between the patient 124 and a remote pharmacist for validation or consultation purposes. As described in the above-identified PCT applications, the automated dispensary kiosk 128 may be implemented in a distributed computing system utilizing a central server that includes, or is linked to, resources that provide quality control, quality monitoring, inventory management, distribution management, and audit functionality in association with the dispensary function of the automated dispensary kiosk 128. In this instance, the messaging server 102 can be implemented as a server component within this distributed computing system.

In one embodiment, the operation of the automated dispensary kiosk 128 for prescription fulfillment involves at least two participants, including the patient 124 and a pharmacist (one example of the health care practitioner 118) remotely connected to the automated dispensary kiosk 128 via the pharmacist's workstation (one example of the user device 116). The pharmacist typically operates to verify information in a presented prescription, verify the correct operation of automated dispensary kiosk 128, and to counsel the patient 124 as necessary.

In response to the presentation of the prescription 127 or other use of the automated dispensary kiosk 128 by the patient 124, the automated dispensary kiosk 128 obtains information 125 regarding one or more of the patient 124, the medicament prescribed, or the pharmacist or pharmacy involved in the dispensing event, and then sends this information, or a filtered representation thereof, to the messaging server 102. The messaging server 102 selects or otherwise obtains one or more messages targeted to one or both of the patient or the pharmacist based on the information 125. Those messages 126 targeted to the patient are transmitted from the messaging server 102 to the automated dispensary kiosk 128 for presentation to the patient 124. Those messages targeted to the pharmacist are transmitted from the messaging server 102 to the pharmacist's workstation for presentation to the pharmacist in the manner described in the first example scenario above.

In the third example scenario, a patient 140 uses a network-connected user device 142 in the course of a health care regime for the patient. The user device 142 can include, for example, a medication adherence device connected to a cell phone of the patient 140, whereby the medication adherence device monitors and reports on the patient's adherence to a treatment regime. Other examples of the user device 142 can include, for example, network-connected devices that monitor blood pressure, heart rate, blood sugar levels, and the like. In this scenario, the user device 142 obtains information 144 regarding the patient 140 or any medicament used in the course of the monitored health care regime, and then sends this information, or a filtered representation thereof, to the messaging server 102. The messaging server 102 selects or otherwise obtains one or more messages targeted to the patient 140 based on the information 144 and then transmits the selected one or more messages 146 to the user device 142 for presentation.

The user devices of the health care messaging system 100 are connected to the messaging server 102 via one or more networks 150, which can include a private network (e.g., a local area network), a public network (e.g., the Internet), or a combination of private and public networks. To illustrate, the user device 116 in the first example scenario may be wirelessly connected to a local area network (LAN) at the office of the health care provider 118, and the LAN in turn is connected to the messaging server 102 via the Internet. As another example, the user device 142 of the third example scenario may connect to the messaging server 102 via a wireless telephony provider. Similarly, the automated dispensary kiosk 128 may connect to the messaging server 102 via, for example, a dial-up connection established via a telephony provider.

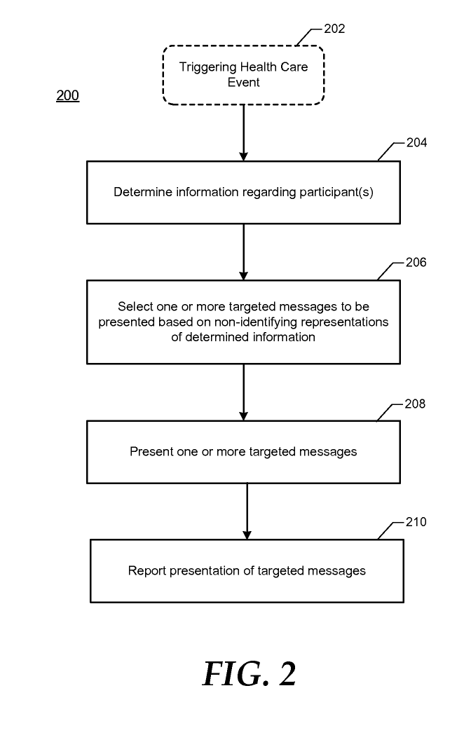

FIG. 2 illustrates an example method 200 for targeted health care messaging in the system of FIG. 1 in accordance with at least one embodiment of the present disclosure. At block 202, a health care event involving a user device occurs, which triggers the targeted messaging process. Non-limiting examples of the health care event can include: the access of a patient's medical records by the user device; the generation of a prescription using the user device; the presentation of a prescription to an automated dispensary kiosk or a pharmacist; the scheduling or ordering of a medical procedure via the user device; the monitoring, reporting, or entry of results of a medical procedure; and a medical research query by a health care provider.

In response to the health care event, the health care messaging system 100 determines information associated with the health care event, including information regarding one or more of the participants in the health care event. Non-limiting examples of the determined information can include: information reflective of the patient's current or previous condition, such as height, weight, body mass index (BMI), gender, blood pressure, blood type, cholesterol levels, bone density values, and the like; information reflective of a treatment history of the patient, including current and prior medications prescribed to the patient, prior medical procedures performed on the patient, and prior medical conditions or diagnoses of the patient; data reflective of the health care provider that is providing care, such as certifications/specialties of the health care provider or a geographical area in which the health care provider is located; information reflective of a medicament being prescribed, such as a brand name or generic name, a drug type, a dosage, a dosage vehicle, or a formulation; and information reflective of a medical procedure ordered or being performed, such as a name or description of the procedure, a diagnosis resulting from the procedure, lab results from the procedure, instruments used during the procedure, and notes taken during performance of the procedure.

In one embodiment, the user device operated by a participant is used to obtain at least a portion of this information. To illustrate, a doctor could use a prescription application executed by a tablet computer to generate a prescription for a patient. In response to the process of generating the prescription, the tablet computer could access a database at the doctor's office to obtain the patient's medical records, from which the desired information can be determined. In another embodiment, the user device provides to the messaging server 102 a subset of information that is sufficient for the messaging server 102 to access the appropriate information from patient records, hospital records, doctor's records, and pharmacy records of the records database 108. To illustrate using the previous example, the tablet computer could send information representing an identifier of the patient and an identifier of the prescribed medicament to the messaging server 102, and the messaging server 102 would then use this subset of information to access the patient's records from the records database 108.

At block 206, the messaging server 102 determines one or more messages targeted to one or more participants in the health care event based on the information obtained at block 204. In addition to selecting the targeted messages based on the information obtained at block 204, the messaging server 102 further may obtain targeted messages further based on the party that is to receive the message. For example, the selection logic may include application of the same core selection criteria for targeting messages to a doctor and a patient being treated by the doctor. However, further selection criteria may provide that the doctor receives a different message than the patient even though the same obtained information is used in both cases. To illustrate, a set of selection criteria may provide for the provision of targeted messages to both a doctor and a patient in response to generation of a prescription for an antihistamine, although the selection criteria may provide that an advertisement for a competing antihistamine is transmitted to the doctor while information regarding allergy mitigation is presented to the patient.

As noted above, the release of potentially identifying information to unauthorized parties may be prohibited. In instances whereby the messaging server 102 is authorized to access confidential information and the message content and selection criteria are locally available to the messaging server 102 (such as via the message database 110 local to the messaging server 102), the messaging server 102 can apply the selection criteria to the obtained information to select the appropriate messages, and thus it may be unnecessary to filter the original information obtained at block 204 as the original information is not made available to unauthorized entities during the message selection process.

However, in other instances whereby the messaging server 102 is not authorized to access confidential information or an unauthorized entity, such as the messaging content providers 104-106, performs the actual message selection process, the health care messaging system 100 operates in a manner that prevents disclosure of such information to the message content providers 104-106 and other unauthorized entities. In one embodiment, this is achieved by filtering the information obtained at block 204 so as to generate filtered information that has a substantially lower possibility of being used ascertain the identity of a participant. The filtering process can include converting a specific value to a value range. To illustrate, if the original information indicates a total blood cholesterol level of 200 milligrams per deciliter (mg/dL), the filtered information instead could indicate a range of, for example, 150 to 240 mg/dL or a range of >200 mg/dL. The filtering process may include converting a narrower range to a broader range. To illustrate, if the original information indicates a body mass index (BMI) of 25 to 27, the filtered information instead to indicate a broader range of 25 to 35. The filtering process further can include the broadening of a classification. To illustrate, the original information could indicate the patient has been prescribed fluoxetine, and the filtered information instead more broadly indicates that the patient has been prescribed an antidepressant. Moreover, the filtering process can include preventing the disclosure of certain combinations of sets of characteristics that together have a measureable potential to serve as an identifier of a particular person. To illustrate, a particular medical condition may affect only a very small number of women while frequently affecting men. In this example, if the original information indicates both this medical condition and the gender of the patient, the filtering process can include removing one of an indicator of the medical condition or an indicator of the gender of the patient, thereby preventing an unauthorized entity from inferring the identity of the patient based on a recognition that the patient is a member of a very small set of people.

In an implementation whereby the messaging server 102 is authorized to access the confidential information, but the messages are selected by an unauthorized entity, the messaging server 102 can perform the filtering process on the original information. To illustrate, the distributed computing system that supports the automated dispensary kiosk 128 typically has authorized access to at least partial records of patients presenting prescriptions, and thus the messaging server 102 can be implemented as part of this computing system. In other implementations whereby the messaging server 102 is not authorized to access confidential information, the information filtering process can be implemented at the user device involved in the health care event or at an intermediary between the user device and the messaging server 102. As described in greater detail below, the user devices can execute a messaging agent that has authorized access to confidential information and which filters this information to generate non-identifying information that is then transmitted to the messaging server 102.

The information obtained at block 204, or the filtered representation thereof, is then used at block 206 to select one or more health care messages from a set of messages based on a comparison of the information to one or more selection criteria associated with the set of messages. To illustrate, a message comprising information regarding a clinical trial of a new cholesterol drug involving men over age 40 could have selection criteria directed to men of age 40 years and older who are overweight and who have recently been prescribed a cholesterol-reducing statin. Accordingly, information associated with a health care event that represents the prescription of a certain dosage of atorvastatin calcium to a patient aged 51 years with a bodyweight of 110 kilograms would trigger selection of the message for the clinical trial due to the information matching the selection criteria.

In one embodiment, message content providers 104-106 provide both the message content and the selection criteria to the messaging server 102, and it is the messaging server 102 that applies the selection criteria to select the appropriate messages based on the obtained information. In another embodiment, the message content and selection criteria are maintained by the message content providers 104-106, and thus it is the message content providers 104-106 that select the appropriate messages based on a query from the messaging server 102. In the latter approach, an oblivious transfer technique, such as a private information retrieval (PIR) protocol, can be implemented by the messaging server 102 to minimize the potential for discovery of the identity of a participant based on the queries made to the message content providers 104-106. In yet another embodiment, targeted messages may be both selected locally by the messaging server 102 using the local message database 110 and selected through queries to one or more of the message content providers 104-106.

At block 208, the one or more targeted messages are transmitted from the messaging server 102 to at least one user device for presentation to at least one participant in the health care event. The targeted messages can include video content, audio content, textual content, graphical content, or combinations thereof. To illustrate, a targeted message can include a graphical advertisement for a prescription drug, an audio public service announcement, a text article reporting new test results in the efficacy of a studied drug, or a video stream depicting the proper way to perform a routine medical procedure. The targeted messages further can include links to additional information or services. To illustrate, the targeted messages may be presented to the participant via a web browser application executed by the corresponding user device, in which case the targeted message can include an extensible markup language (XML) link to a website for the purposes of offering continuing medical education (CME) materials related to the performance of a medical procedure that served as the health care event.

At block 210, the messaging server 102 reports the provision of the one or more targeted messages. The resulting reports can indicate the targeted messages that were issued and the sets of information that triggered their issuance, the number of times a particular message was issued, the frequency of issuance of a particular message, and the like. These reports can be used to bill the message content providers or associated entities for the delivery of the targeted messages, as well as being used by the message content providers to analyze and refine the selection criteria for the messages.

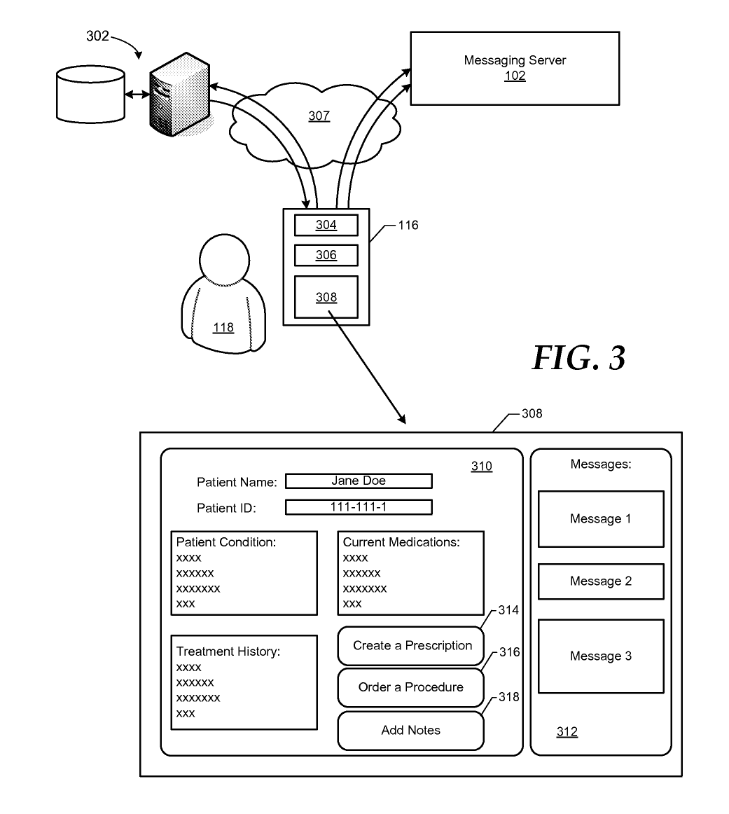

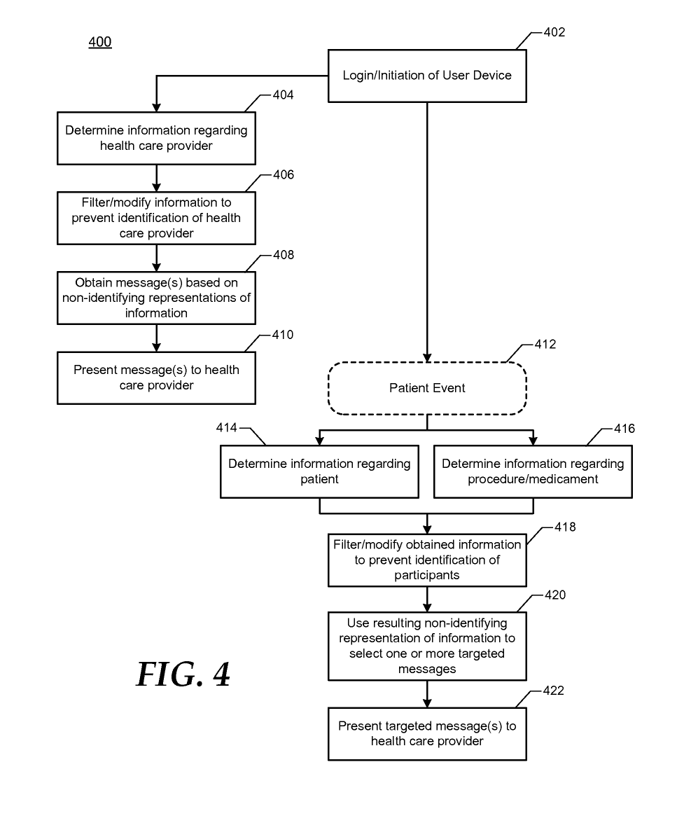

FIGS. 3 and 4 illustrate the first example scenario involving the health care provider 118 and the user device 116 in greater detail. The third example scenario involving a patient's use of the user device 142 can proceed in a manner similar to the process described below. In the depicted embodiment of FIG. 3, the health care provider 118 maintains a medical records system 302 that stores the medical records of patients treated by the health care provider. The user device 116 includes a tablet computer, notebook computer, desktop computer, personal digital assistant or other networked computing device that executes an electronic medical records (EMR) application 304. The EMR application 304 has access to the medical records database 302 via a wireless local area network 307. The user device 116 further includes a graphical user interface (GUI) 308 that the health care provider 118 can use to interact with the EMR application 304 so as to access a patient's medical records, generate a prescription, enter notes, and the like. To illustrate, the GUI 308 can be implemented via a touch screen and can include a web browser or other GUI that includes a patient information display region 310 and a message display region 312. The patient information display region 310 can include, for example, a display of patient information, such as the patient's name, an ID number, the current condition of the patient (e.g., height, weight, blood pressure, etc.), the current medications taken by the patient, the treatment history of the patient, and so forth. The message display region 312 includes a region in which messages with visual content are presented to the health care provider 118. The messages can be presented in parallel, in a scrolling format, in an alternating format, or a combination thereof. The GUI 308 further can include user-operable buttons or other user-selectable features for implementing certain functionality of the EMR application 304, such as a prescription button 314 to initiate a GUI for generating a prescription for the patient, a procedure order button 316 to initiate a GUI for ordering or scheduling a medical procedure, or a note button 318 to initiate a GUI to enter notes in association with an examination of the patient or a medical procedure performed on the patient.

The user device 116 further includes a messaging agent 306 executed in association with the EMR application 304. In one embodiment, the EMR application 304 is implemented as a website accessed through a web browser at the user device 116, and the messaging agent 306 is implemented as a browser plug-in for execution in association with the website. The messaging agent 306 interacts with the EMR application 304 to collect information in association with the health care provider's operation of the user device 116, filter this information as appropriate so as to remove potentially identifying information, and provide the information, or its filtered representation, to the messaging server 102. The messaging server 102 in turn obtains one or more targeted messages based on the received information and provides the targeted messages to the messaging agent 306 for presentation via the message display area 312.

FIG. 4 illustrates an example method 400 of targeted health care messaging in association with a health care provider's use of the user device 116 of FIG. 3 in accordance with at least one embodiment of the present disclosure. At block 402, the health care provider 118 logs into the user device 116 or otherwise initiates operation of the user device 116. In response to this event, the messaging agent 306 accesses information regarding the health care provider 118 at block 404. This information can be accessed from, for example, electronic medical records used by a doctor, pharmacy, or hospital. The information may include information representing the certifications, specializations, affiliations and memberships of the health care provider 118, the geographical location of the health care provider 118, and the like. At block 406, the messaging agent 306 filters or otherwise modifies this information as necessary to prevent inference of the identity of the health care provider 118 from the information. At block 408, the messaging agent 306 provides the resulting filtered information to the messaging server 102, which uses the information and various selection criteria to obtain one or more messages targeted to the health care provider 118. The messaging server 102 transmits the message content to the messaging agent 306 and at block 410 the messaging agent 306 presents the targeted messages to the health care provider via, for example, the message display area 312 of the GUI 308. The targeted messages at this stage can include, for example, a scrolling ticker tape-type display of news related to the medical specialty of the health care provider 118. The targeted messages at this stage can include, for example, information from a news service, journal articles pertaining to the health care provider's specialty, ministry announcements, and the like.

At some point, the health care provider 118 uses the user device 116 in conjunction with the treatment of a patient (illustrated as patient event 412 in FIG. 4). For example, the health care provider 118 may operate the user device 116 to obtain the patient's medical records or to generate a prescription for the patient. In response, at block 414 the messaging agent 306 accesses various information regarding the patient, such as the patient's current condition, the patient's treatment history and medication history, and the like. If the triggering patient event is the prescription of a medicament, at block 416 the messaging agent 306 accesses information about the prescribed medicament, such as the type, formulation, or dosage of the medicament. If the triggering patient event is the scheduling or performance of a medical procedure, at block 416 the messaging agent 306 accesses information about the medical procedure, such as the type of medical procedure, the instruments used in the medical procedure, or the results or notes generated through performance of the medical procedure.

At block 418, the messaging agent 306 filters the information obtained at blocks 414 and 416 so as to prevent identification of any participant in the patient event from the resulting filtered information. Alternatively, the messaging agent 306 can provide the original information to the messaging server 102, which in turn filters the information. At block 420, the messaging agent 306 provides the resulting filtered information to the messaging server 102, which uses the information and various selection criteria to obtain one or more messages targeted to one or both of the health care provider 118 or the patient. To illustrate, the selected messages can include an offer for a sample of the prescribed medicament or a competing medicament, an offer for a compliance program, an explanation of the patient's medical insurance or benefits coverage, and the like. The messaging server 102 transmits the message content to the messaging agent 306 and at block 422 the messaging agent 306 presents the targeted messages to the health care provider via, for example, the message display area 312 of the GUI 308.

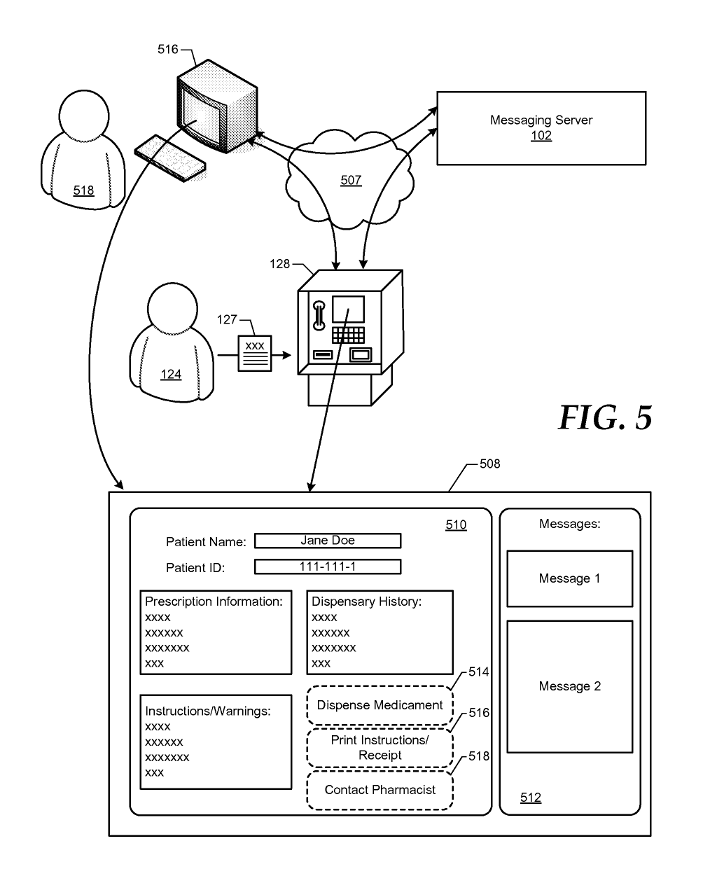

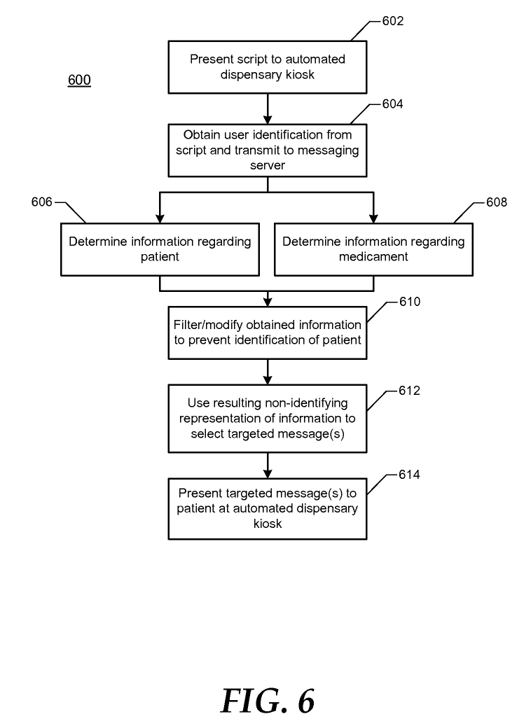

FIGS. 5 and 6 illustrate the third example scenario of FIG. 1 involving the patient 124 and the automated dispensary kiosk 128 in greater detail. In the depicted embodiment of FIG. 5, the automated dispensary kiosk 128 is maintained at a doctor's office, a medical clinic, a pharmacy, or other suitable location. The messaging server 102 is connected to the automated dispensary kiosk 128 via, for example, a modem link over a telephony network 507. In this instance, the messaging server 102 may be implemented as part of a central server that provides dispensary, validation, and consultations services for patients that interact with the automated dispensary kiosk 128. As noted above, the automated dispensary kiosk 128, in one embodiment, is remotely connected to a pharmacist 518 (one embodiment of the health care provider 118) via a workstation 516 (one embodiment of the user device 116), whereby the pharmacist 518 remotely facilitates the patient's interaction with the automated dispensary kiosk 128.

In one embodiment, each of the workstation 516 and the automated dispensary kiosk 128 implements a GUI for interfacing with the pharmacist 518 and the patient 124, respectively, during a process of fulfilling a prescription. For ease of discussion, these GUIs are illustrated in FIG. 5 as the same GUI 508. The GUI 508 can be implemented via, for example, a touch screen or a display and a separate keyboard or other user input mechanism. The GUI 508 can include a patient information display region 510 and a message display region 512. The patient information display region 510 can include, for example, a display of prescription information, prior prescriptions fulfilled by the automated dispensary kiosk 128 or an associated kiosk, instructions or warnings for the prescription being fulfilled, and so forth. The message display region 512 includes a region in which messages with visual content are presented to the patient 124 (at the automated dispensary kiosk 128) or to the pharmacist 518 (at the workstation 516). The messages can be presented in parallel, in a scrolling format, in an alternating format, or a combination thereof. The GUI of the workstation 116 of the pharmacist 118 further can include user-operable buttons or other user-selectable features for implementing certain functionality of the automated dispensary kiosk 128, such as a dispense button 514 to direct the automated dispensary kiosk 128 to dispense the medicament indicated by the prescription 127, a print receipt button 516 to direct the automated dispensary kiosk 128 to print out a receipt for the prescription or to print out instructions for taking the prescribed medicament, and a contact button 518 to direct the automated dispensary kiosk 128 to initiate a teleconference or video conference with the patient 124 so as to render assistance to the patient 124.

Both the workstation 516 and the automated dispensary kiosk 128 include a messaging agent to collect information in association with the prescription fulfillment event, filter this information as appropriate so as to remove potentially identifying information, and provide the information, or its filtered representation, to the messaging server 102. The messaging server 102 in turn selects one or more targeted messages based on the received information and the party targeted by the message (that is, patient or pharmacist) and provides the targeted messages to the messaging agent for presentation via the message display area 512.

FIG. 6 illustrates an example method 600 of targeted health care messaging in association with a patient's use of the automated dispensary kiosk 128 of FIG. 5 in accordance with at least one embodiment of the present disclosure. At block 602, the patient 124 presents the prescription 127 to the automated dispensary kiosk 128 for fulfillment. In response to this health care event, at block 604 the automated dispensary kiosk 128 scans the prescription 127 to identify one or more of the patient 124, the pharmacist 518, the prescribing health care provider, and the prescribed medicament and the automated dispensary kiosk 128 then transmits this information to a central server (not shown). The central server uses this identification information to access the patient's records for purposes of processing prescription 127. Concurrently, at blocks 606 and 608 the messaging server 102 accesses the patient's records via the central server so as to obtain information regarding the patient and the prescribed medicament, respectively. The obtained patient information can include information representing the patient's current health condition, the patient's treatment history and medication history, and the like. The information regarding the medicament can include, for example, the type, formulation, or dosage of the medicament.

At block 610, the messaging server 102 filters the information obtained at blocks 606 and 608 so as to prevent identification of the patient from the resulting filtered information. At block 612, the messaging server 102 uses the information and various selection criteria to obtain one or more messages targeted to the patient based on the information. To illustrate, the selected messages can include an offer for a sample of the prescribed medicament or a competing medicament, an offer for a compliance program, an explanation of the patient's medical insurance or benefits coverage, and the like. The messaging server 102 transmits the message content to the messaging agent of the automated dispensary kiosk 128 and at block 614 the messaging agent presents the targeted messages to the patient via, for example, the message display area 512 of the GUI 508 for the automated dispensary kiosk 128. Likewise, the messaging server 102 uses information obtained about the pharmacist and various selection criteria to obtain one or more messages targeted to the pharmacist and transmits the targeted messages to the pharmacist's workstation for presentation in the manner described above with reference to FIGS. 3 and 4.

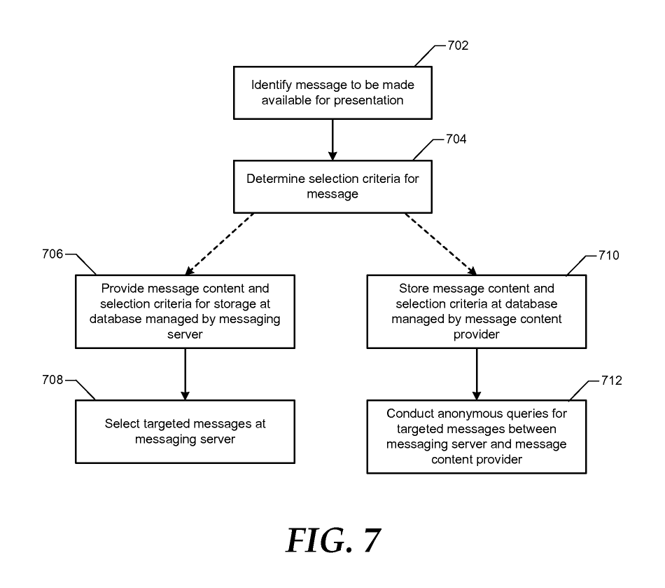

FIG. 7 illustrates two alternative approaches for selecting targeted health care messages in a manner that prevents a message content provider or other unauthorized entity from inferring a participant's identity. In either approach, a message to be made available for presentation by the health care messaging system 100 is identified by a message content provider at block 702. Further, at block 704 the message content provider determines the desired characteristics of the participant or the health care event to be specifically targeted by the message and from these desired characteristics the message content provider determines the appropriate selection criteria. As an example, the message content provider may provide an advertisement for a blood pressure drug as the message. In an effort to reach the appropriate audience for this message (that is, the health care providers prescribing blood pressure medicines and patients at risk of high blood pressure), the message content provider may set as selection criteria a requirement that supplied information identify a patient with above-average blood pressure. As another example, the message may include information regarding a clinical trial for a new cholesterol drug and the selection criteria may include a requirement that supplied information identify a doctor who has recently prescribed a cholesterol drug to one or more patients.

Under one approach, at block 706 the message content provider provides the message content and selection criteria determined at blocks 702 and 704 to the messaging server 102. The messaging server 102 then stores the received information at the local message database 110. At block 708, the messaging server 102 can locally identify and select targeted messages based on the selection criteria from the local message database 110. Thus, confidential information with the potential of identifying a participant is not released to, or accessible by, the message content provider or other unauthorized third party.

In certain instances, the message content provider may desire to maintain the selection criteria for a message in confidence. Accordingly, in an alternative approach the message content provider stores, at block 710, the message content and selection criteria at one or more databases managed by the message content provider. As the selection criteria is not available to the messaging server 102, at block 710 the messaging server 102 conducts anonymous queries to the message content provider using information obtained in association with a health care event. The anonymity of the participants can be maintained in part by filtering of the information so as to lessen the chance that the identity of a participant can be inferred from the information. The filtering process can be performed at the messaging server 102, at a messaging agent executed at the user device involved in the health care event, or a combination thereof. Further, the messaging server 102 can use oblivious transfer techniques, such as by conducting queries in accordance with a PIR protocol, so as to prevent the message content provider from discerning the identity of a participant on the basis of the nature of the queries. The messaging server 102 further can obfuscate the identities of the participants by removing any identifying information of the user devices, such as by stripping IP addresses and MAC addresses from the communications of the user devices.

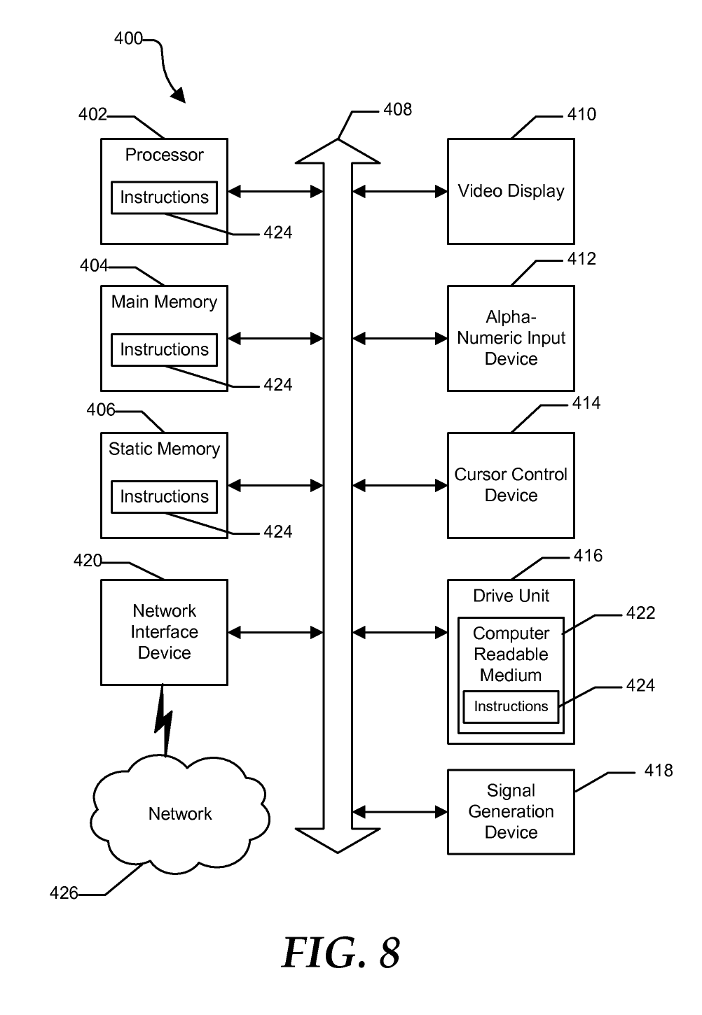

FIG. 8 shows an illustrative embodiment of a general computer system 800 in accordance with at least one embodiment of the present disclosure. The computer system 800 can include a set of instructions that can be executed to cause the computer system 800 to perform any one or more of the methods or computer-based functions of the messaging server 102, the user devices, or other computer-based components disclosed herein. The computer system 800 may operate as a standalone device or may be connected via a network to other computer systems or peripheral devices.

In a networked deployment, the computer system may operate in the capacity of a server or as a client user computer in a server-client user network environment, or as a peer computer system in a peer-to-peer (or distributed) network environment. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

The computer system 800 may include a processor 802, such as a central processing unit (CPU), a graphics processing unit (GPU), or both. Moreover, the computer system 800 can include a main memory 804 and a static memory 806 that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard or touch screen, and a cursor control device 814, such as a mouse. The computer system 800 can also include a disk drive unit 816, a signal generation device 818, such as a speaker or remote control, and a network interface device 820.

In a particular embodiment, as depicted in FIG. 8, the disk drive unit 816 may include a computer-readable medium 822 in which one or more sets of instructions 824, such as software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media. The network interface device 820 can provide connectivity to a network 826, such as a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions or receives and executes instructions responsive to a propagated signal, so that a device connected to a network can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writeable memory. Additionally, the computer-readable medium can include a magneto-optical or optical medium, such as a disk or tapes or other storage device.

Although the present specification describes components and functions that may be implemented in particular embodiments with reference to particular standards and protocols, the invention is not limited to such standards and protocols. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The Abstract of the Disclosure is provided with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A computer-implemented method for providing targeted health care messages from at least one message content provider, the method comprising:
in response to a health care event, obtaining information regarding one or more of: at least one participant associated with the health care event; a medical procedure associated with the health care event; or a medicament associated with the health care event in a manner that prevents identification of the at least one participant by the at least one message content provider; and
selecting one or more messages for presentation to a participant associated with the health care event based on the information.

2. The method of claim 1, wherein the information comprises information regarding at least one participant, the at least one participant comprising a health care provider associated with the health care event.

3. The method of claim 2, wherein the information comprises information regarding at least one of: a practice area of the health care provider; a geographical area of the health care provider; and a certification of the health care provider.

4. The method of claim 1, wherein the information comprises information regarding at least one participant, the at least one participant comprising a patient associated with the health care event.

5. The method of claim 4, wherein the information comprises information regarding at least one of: a medicament prescribed to the patient; a medical procedure performed on, or scheduled to be performed on, the patient; and a health condition of the patient.

6. The method of claim 1, wherein the information comprises information regarding a medical procedure associated with the health care event.

7. The method of claim 6, wherein the medical procedure comprises at least one of a surgical procedure or a diagnostic procedure.

8. The method of claim 1, wherein the information comprises information regarding a medicament prescribed to a patient associated with the health care event.

9. The method of claim 8, wherein the information regarding the medicament comprises at least one of: a formulation of the medicament; a type of the medicament; and a dosage of the medicament.

10. The method of claim 1, further comprising:
presenting the one or more messages to the participant.

11. The method of claim 10, wherein the one or more messages comprise a message with visual content and presenting the one or more messages comprises displaying the visual content.

12. The method of claim 10, wherein the one or more messages comprise a message with audio content and presenting the one or more messages comprises a playback of the audio content.

13. The method of claim 1, wherein the health care event comprises at least one of: a generation of a prescription for a medicament for a patient; a presentation of the prescription to a pharmacy for fulfillment; the scheduling of a medical procedure for a patient; the performance of a medical procedure on a patient; and an access to, or modification of, a patient's medical records.

14. The method of claim 1, wherein obtaining the information in a manner that prevents identification of the at least one participant comprises preventing inclusion of information unique to a participant.

15. The method of claim 1, wherein obtaining the information in a manner that prevents identification of the at least one participant comprises modifying more specific information associated with a participant to comprise more general information.

16. The method of claim 15, wherein modifying the more specific information comprises at least one of converting a specific value to a range of values; converting a narrower range to a broader range; converting a narrower classification to a broader classification; and preventing inclusion of a particular set of characteristics determined to be sufficient in combination to permit identification of a participant.

17. The method of claim 1, wherein:
obtaining the information in a manner that prevents identification of the at least one participant comprises:
obtaining the information in a first computing system managed by an entity authorized to access an identity of the at least one participant;
processing the information to render filtered information that does not identify the participant; and
providing the filtered information to a second computing system that is not authorized to access the identity of the at least one participant; and
selecting the one or more messages for presentation comprises selecting the one or more messages at the second computing system based on the filtered information.

18. The method of claim 17, wherein the first computing system comprises a computing system managed in association with a health care provider participating in the health care event and the second computing system comprises a computing system managed in association with the at least one message content provider.

19. The method of claim 17, wherein the health care event comprises a presentation of a prescription to an automated dispensary kiosk, the first computing system comprises a computing system managed in association with the automated dispensary kiosk, and the second computing system comprises a computing system managed in association with the at least one message content provider.

20. The method of claim 1, wherein:
obtaining the information in a manner that prevents identification of the at least one participant comprises:
obtaining the information in a first computing system managed by an entity authorized to access an identity of the at least one participant;
obtaining, at the first computing system, message content representative of a set of one or more messages from a second computing system that is not authorized to access an identity of the at least one participant;
obtaining, at the first computing system, selection criteria for messages of the set of messages from the second computing system; and
selecting the one or more messages for presentation comprises selecting the one or more messages at the first computing system based on the information and the selection information.

21. The method of claim 20, wherein the first computing system comprises a computing system managed in association with a health care provider participating in the health care event and the second computing system comprises a computing system managed in association with the at least one message content provider.

22. The method of claim 20, wherein the health care event comprises a presentation of a prescription to an automated dispensary kiosk, the first computing system comprises a computing system managed in association with the automated dispensary kiosk, and the second computing system comprises a computing system managed in association with the at least one message content provider.

23. The method of claim 1, wherein:
the health care event comprises a generation of a prescription of a medicament for a patient by a health care provider via a user device operated by the health care provider;
the information comprises at least one of information regarding the medicament, a treatment history of the patient, and a health condition of the patient; and
the method further comprises presenting the one or more messages to the health care provider via the user device.

24. The method of claim 1, wherein:
the health care event comprises a presentation of a prescription of a medicament from a patient to an automated dispensary kiosk;
the information comprises at least one of information regarding the medicament, a medical history of the patient, and a health condition of the patient; and
the method further comprises presenting the one or more messages to the patient via the automated dispensary kiosk.

25. A computing system for providing targeted health care messages from at least one message content provider, the computing system comprising:
a messaging server to, in response to a health care event, provide one or more messages for presentation to a participant associated with the health care event based on information regarding one or more of: at least one participant associated with the health care event; a medical procedure associated with the health care event; or a medicament associated with the health care event, the information obtained in a manner that prevents identification of the at least one participant by the at least one message content provider.

26. The system of claim 25, wherein:
the messaging server is to process the information to render filtered information that does not identify the at least one participant and to provide the filtered information to the at least one message content provider; and
the at least one message content provider is to select the one or more messages based on the filtered information.

27. The system of claim 25, wherein:
the messaging server is to receive a set of messages and selection criteria for the set of messages from the at least one message content provider and to select the one or more messages from the set of messages based on the selection criteria.

28. The system of claim 25, further comprising:
a user device to present the one or more messages to the participant.

29. The system of claim 28, wherein the user device is to obtain at least a portion of the information and to provide the obtained portion of the information to the messaging server.

30. The system of claim 28, wherein the user device is to obtain at least a portion of the information, process the obtained portion to render filtered information that does not identify the at least one participant, and to provide the filtered information to the messaging server.
